(19) United States
(12) Patent Application Publication
(10) Pub. No.: US 2006/0146805 A1
(43) Pub. Date: Jul. 6, 2006

(54) Systems and methods of providing voice communications over packet networks

(76) Inventor: Brian Gregory Krewson, Colorado Spring, CO (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/314,333

(22) Filed: Dec. 21, 2005

Related U.S. Application Data
(60) Provisional application No. 60/641,409, filed on Jan. 5, 2005.

(51) Int. Cl. H04L 12/66

(52) U.S. Cl. 370/352

(57) ABSTRACT

Aspects of the invention relate to systems and methods of providing voice communications over a packet switched network having one or more client device connected on a low bandwidth connection. One aspect allows VOIP connections to adapt to the various, and potentially changing conditions, caused by different connection types and transmission qualities. One aspect modifies the data, the encryption methods, the sampling frequencies, and other parameters of the VOIP configuration to improve the functioning of the VOIP communication. These parameters may be changed based on the connection types and transmission quality of both the sending and receiving devices, among other factors. Another aspect of the present invention relates to methods of predictive voice transmission by constantly recording into a buffer and only transmitting portions of the buffered recording based on the presence of voice.

### CROSS-REFERENCE TO RELATED APPLICATIONS

The present application claims priority to U.S. provisional application No. 60/641,409, entitled “System and Method of Providing Voice Communications Over Packet Networks,” filed on Jan. 5, 2005, the entirety of which is incorporated herein by reference.

### FIELD OF THE INVENTION

The present invention relates generally to voice communications and, more particularly, to optimizing systems and methods of voice communications, and other streaming communication protocols, over packet networks.

### BACKGROUND

Streaming media, voice-over packet switched and voice-over Internet protocol (“VOIP”) applications and devices do not work well when one or more of the client devices is connected by a latent connection such as a wireless or dial up connection. These environments or connection types are usually much slower in speed or bandwidth, and have the potential to result in an increased number of dropped packets, greater interference, and drastically changing signal strengths. These characteristics present challenges for any VOIP installations, devices or systems designed to allow for latent client device connections. In addition, VOIP connections typically involve service charges based on the number of packets or amount of data transmitted rather than the duration of the connection. Accordingly, it is valuable to avoid constant transmissions when possible, or at least to avoid transmitting useless or non-content data.

Furthermore, streaming installations involving two-way audio communications, such as VOIP, are very latency sensitive and generally cannot use buffering to make up for the latency and other problems associated with latent connections. For these reasons, VOIP applications and devices have traditionally been used with and designed for high bandwidth connections rather than lower bandwidth or latent connections. Because VOIP applications are not designed for systems having latent connection types, conventional VOIP applications generally do not have functionality to enable, optimize, or improve connection and transmission quality based on the quality of the transmission or the quality of reception by the recipient.

Conventional VOIP applications and devices also do not adequately and conveniently facilitate the capturing and transmitting of voice data over latent connections. A typical VOIP system involves components for recording, encoding, and transmitting voice data. Once the voice data is received by a recipient, it is decoded back into an audio stream and played aloud. Most conventional VOIP implementations utilize VOIP client devices that are connected to a gateway or other computer on local and, usually, high speed connections. Although the basic procedure is essentially the same in all VOIP implementations, some variation is possible with respect to when the voice data is recorded, encoded, and transmitted.

There are several common alternatives in VOIP implementations. The first involves capturing or recording everything and then transmitting everything. This is similar to the way a standard telephone works as even silence is captured and transmitted. Data is constantly transmitted and everything (sound and silence data) is constantly received on the other end. The second involves selectively transmitting only the voice or other desired sounds. There are two general ways of accomplishing this selective transmission: push-to-talk (“PTT”) and Voice Operated eXchange (“VOX”). PPT, as the name suggests, involves recording and transmitting only when a button is pressed. This functions similar to a push-to-talk walky-talky in that when the user starts pushing, the device starts recording and transmitting. Users typically find PTT systems inconvenient to use because they require constant user action to control the recording or capturing of the user's voice. VOX is voice detection that detects the presence and absence of voice sound waves. In VOX based systems, the device starts recording and transmitting when voice is detected. One problem with VOX is that it takes a non-negligible amount of time for the hardware to recognize that voice is occurring and start recording. This causes the initial portions of sentences to be left out of the transmission, making the transmission sound choppy and incomplete. Current systems and applications, do not provide for convenient and smooth-sounding selective voice data transmission, and are particularly ill suited for systems allowing latent connection types or otherwise having bandwidth limitations that make constant transmission undesirable.

### SUMMARY OF THE INVENTION

The present invention relates to systems and methods of providing voice communications over a packet switched network having one or more client device connected on a low bandwidth connection. The methods, devices, and systems have various uses in streaming media delivery, half duplex (instant messaging for text, voice, and video) and full-duplex (conversational voice & video conferencing) communications. These methods also have potential applications in cellular WWAN networks (GPRS, etc.) and non-wireless connections such as dialup connections. One aspect of the present inventions provides an application that allows VOIP connections to adapt to the various, and potentially changing conditions, caused by different connection types and transmission qualities. One aspect of the invention modifies the data, the encryption methods, the sampling frequencies, and other parameters of the VOIP configuration to improve the functioning of the VOIP communication. These parameters may be changed based on the connection types and transmission quality of both the sending and receiving devices, among other factors.

Another aspect of the present invention relates to methods of predictive voice transmission. By constantly recording into a buffer and only transmitting portions of the buffered recording based on the presence of voice, these methods provide significant advantages over the current communication systems that require user interaction (push-to-talk applications) or that have choppy and incomplete transmissions (current VOX applications). Other aspects of the present invention provide additional benefits to voice over packet switched networks and VOIP implementations, allowing the use of client devices connected via lower bandwidths than typically high speed network connections.

### BRIEF DESCRIPTION OF THE DRAWINGS

These and other features, aspects, and advantages of the present invention are better understood when the following Detailed Description is read with reference to the accompanying drawings, wherein:

FIG. 1 is a system diagram of an exemplary system according to one embodiment of the present invention;

FIG. 2 is a system diagram of an exemplary audio engine according to one embodiment of the present invention;

FIG. 3 is a flow diagram of an exemplary method in accordance with one embodiment of the present invention; and

FIG. 4 is a flow diagram of an exemplary method in accordance with one embodiment of the present invention.

### DETAILED DESCRIPTION

The present invention relates to systems and methods of providing voice communications over packet networks. Some embodiments of the invention provide improved methods of using client devices capable of connecting to a network using different connection types. The embodiments of the present invention allow the enhancement of voice data transmission over various network and connection types including wireless and other relatively low bandwidth networks or connection types. The methods, devices, and systems have various uses in streaming media delivery, half duplex (instant messaging for text, voice, and video), and full-duplex (conversational voice & video conferencing) communications. These methods also have potential applications in cellular WWAN networks (GPRS, etc.) and non-wireless connections such as dialup connections.

A. Automatic Setting Selection

One embodiment of the present invention provides an application that allows VOIP connections to adapt to the various, and potentially changing conditions, caused by different connection types. This may involve making modifications to parameters or settings such as the encryption method or the sampling frequency to improve the functioning of the VOIP communication. These parameters or settings may be changed based on the connection types and connection quality of both the sending and receiving devices, among other factors. This has particular advantages in the VOIP applications that utilize or are capable of utilizing connections having higher latency and slower connection speeds.

In one embodiment, the invention provides real time automatic program property selection. While conventional VOIP applications select the optimum sampling frequency, optimum compression ratio, and other properties based on the sending devices connection type, the present invention provides devices and methods that may take into account the receiving connection type and/or the transmission quality and speed. In contrast to conventional VOIP applications which are connection agnostic, one embodiment of the present invention monitors the actual transmission of data by communicating with the recipient. This solves many problems that arise in systems in which settings are based solely on the sender's connection type. For example, problems may arise if the recipient on the other end is not connected on a similar connection type. In such a case, one client machine may send huge amounts of data because it detected a high speed connection. However, that data may be received by a client device connected on a connection that cannot handle that huge amount of data. Applications that make the assumption that the receiving machine has a similar connection to the sending machine may not allow for systems that have connection types with a wide range of connection speeds. More specifically, this assumption has significant disadvantages if low bandwidth connections are used on the same VOIP system as higher bandwidth connections.

These problems are avoided by monitoring the transmission of voice data and making real-time, communication property adjustments based on the information about the transmission. This information may include communication speed, communication quality, reception quality, responses to queries from the sending computer, or any other type of information that provides a basis for making a communication property or setting adjustment. For example, a sending machine could send a request to the receiver asking how much of a set amount of transmitted data was actually received and whether that data was in the correct order. The sending or hosting computer may then make changes to its communication settings based on the responses or lack of responses received back from the receiving computer.

Another aspect of the present invention periodically repeats the sending of information about connection quality, reception quality, etc. so that adjustments may also be periodically made. This monitors for changes in the connection type and connection quality and allows the communication properties or settings to be adjusted if the connection types or quality are changed. Furthermore, periodic information sending and adjustments allow individual settings to be fine tuned to an optimal setting value. For example, the sending computer can make a small change and then query the recipient as to whether the change caused improvement or not. And then repeat this process until the optimal setting is determined.

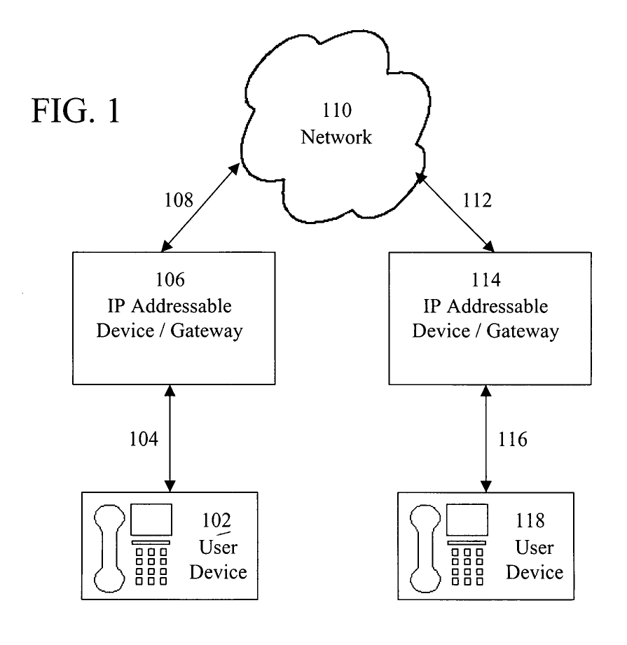

FIG. 1 is a system diagram of an exemplary system according to one embodiment of the present invention. As shown, network 110 is attached to two IP addressable devices or gateways 106, 114 by network connections 108, 112. The network 110 is not limited to any particular type of network nor is it limited to a single network. For example, the network 110 could be the Internet, a LAN, a WAN, a private network, a virtual network, or any combination of network types. The two IP addressable devices or gateways 106, 114 are each then attached to a user device 102, 118, each of which is a client device. While the network connections 108, 112 shown in FIG. 1 will most likely be high speed connections, the device connections 104, 116 may be slower connections having a higher latency.

As shown, VOIP client devices 102, 118 are not required to themselves be a part of the network 110. The gateways 106, 114 provide a way for client devices to connect to the network using different protocols and connection types. The term gateway is generally used herein to refer to hardware (computer or server) or software that bridges the gap between two otherwise incompatible applications or networks so that data can be transferred among different computers or systems. A gateway or router may be a computer system or other device that acts as a translator between two systems that do not use the same communication protocols, data-formatting structures, languages, and/or architecture. A gateway may repackage information or change its syntax to match the destination system or device. A gateway may also provide filtering and security functions, as in the case of a proxy server and/or firewalls. One or both of the gateways 106, 114 may not be required if one or both of the client devices 102, 118 are compatible or otherwise connectable to the network 110.

The client device connections 104, 116 may be virtually any type of network, line, or wireless connection. For example, the connection 104, 116 could involve local area networks (“LANs”), dial up modems, Wi-Fi, wireless local area networks (WLANs), wireless wide area networks (WWANs), or cellular. The current invention is connection agnostic and can work across any suitable network connection. WWAN link connections may also be used. Although WWAN link connections offer many advantages, they generally have a slow bit rate and are interference prone. WWAN connections are often subject to RF fades, dropped packets, and drastically changing signal strengths that may cause dynamic changes in the bit rates. WWAN link connections may also be subject to long, variable latency and to asymmetric throughput—i.e. having higher throughput in the downlink (base station to mobile) than on the uplink (mobile to base station). VOIP connections also typically involve service charges based on the number of packets or amount of data that is transmitted rather than the length of the connection. Thus, it is valuable to avoid constant transmissions when possible, or at least to avoid transmitting useless or non-content data. The automatic setting selection features of some embodiments of the present invention allow VOIP to utilize these connection types by making appropriate settings adjustments.

The device connections 104, 116 may change over time and even during the course of an established communication connection between user device 102 and user device 118. The different types of device connections 104, 116 may have characteristics that differ significantly from one another and impose requirements on the system and the network 110. In addition, the client devices 102, 118 themselves may have differing characteristics. The client devices 102, 118 may include cell phone devices, mobile phone devices, smart phone devices, pagers, notebook computers, personal computers, digital assistants, personal digital assistants, digital tablets, laptop computers, Internet appliances, blackberry devices, Bluetooth devices, standard telephone devices, fax machines, other suitable computing devices, or any other device capable of capturing, recording, and/or transmitting voice data. Generally, a client device 102, 118 will include a component for capturing voice data and a component for transmitting or moving that data to another location. Additional components in the client devices may differ and provide various functionalities. In general, a client device 102, 118 may use any suitable type of processor-based platform and typically will include a processor coupled to a computer-readable medium, such as memory. The computer readable medium can contain program code that can be executed by the processor. The present inventions reduces many of the problems caused by the many differences in connection types and client devices.

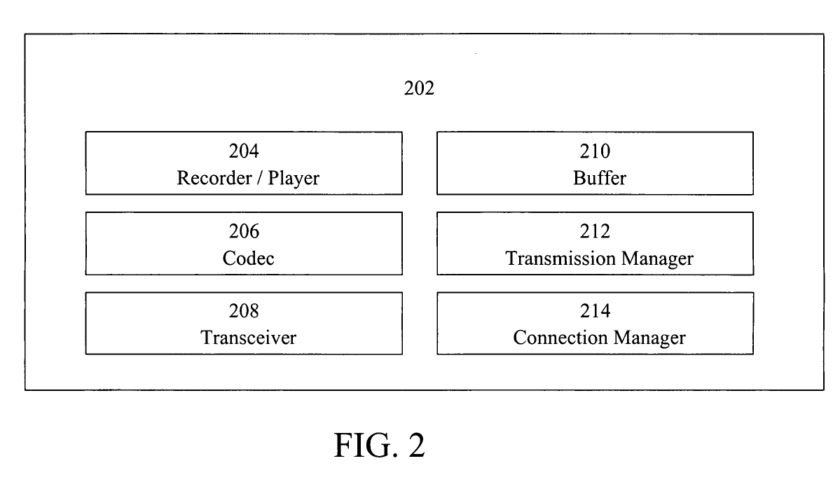

FIG. 2 is a system diagram of an exemplary audio engine 202 that may be part of a client device 102, 118 according to one embodiment of the present invention. As shown, the basic components that may be a part of an audio engine are a recorder/player 204, a coder/decoder (“codec”) 206, a transceiver 208, a buffer 210, a transmission manager 212, and a connection manager 214. These components can include hardware or software, such as program code capable of being executed by a processor. The components work together in a VOIP or voice over packet switched network to take words and sounds (sound waves) convert them to sound or voice data, encode this data, and transmit this data to a recipient. The recorder/player 204 may include conventional recording devices such as microphones and conventional playing devices such as speakers. The recorder and player are generally used to convert sound waves to analog or pulse modulated form and vice versa.

A codec 204 is a device used to encode and decode (or compress and decompress) various types of data. Common codecs include those for converting analog sound signals into digitized sound. Codecs generally may be used with either streaming, file-based (e.g. WAV), or live content. In VOIP embodiments of the present invention, the codec 204 is generally an integrated circuit or other electronic device combining the circuits needed to convert digital, analog, or pulse modulated signals to an appropriate form. The specific operation of the codec 204 may be controlled by an application or component such as a transmission manager 212. For example, the transmission manager 212 may have the codec 204 take an analog signal from the recorder 204 and convert it to a compressed digital signal. The transmission manager 204 may than have the transceiver 208 transmits this signal to either a gateway 106 or directly on a network 110.

The buffer 210 may be used in a variety of ways to store data before or after it is converted by the codec 204. The transmission manager 212 may control the recording and playing at the recorder/player 204, the coding and decoding at the codec 206 and/or the transmission and receipt at the transceiver 208. The connection manager 214 may control the connection of the audio engine to the recipient at the other end of the VOIP communication. For example, if the audio engine 202 is part of a client device 102, the connection manager 214 may manage the connection to the network 110 and gateway 106. The transmission manager 212 and connection manager 214 may be software applications that reside in memory and are executed by a processor. The transmission manager 212 and connection manager 214 may also include hardware components.

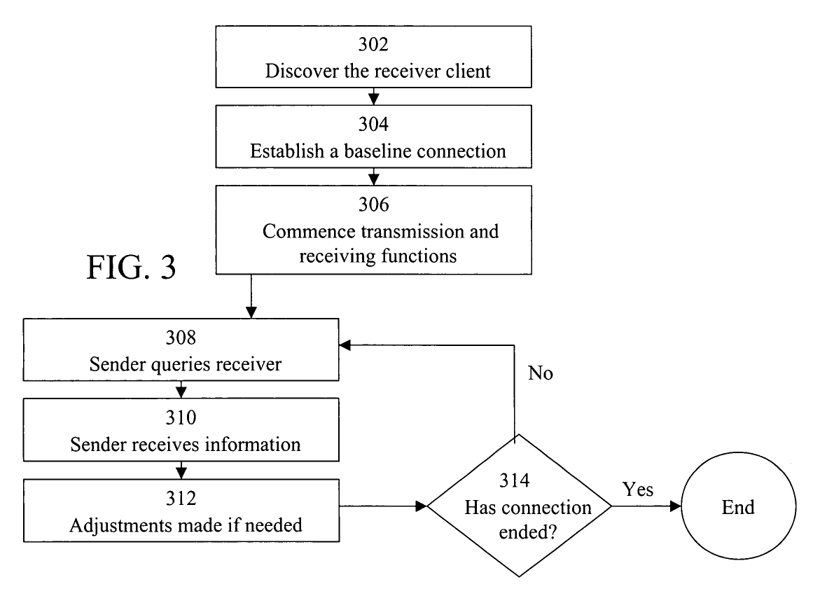

FIG. 3 is a flow diagram of an exemplary method in accordance with an embodiment of the present invention. In block 302, the receiver client is discovered. The receiver client may be discovered by determining the address of the computer or client to which the voice over packet network connection will be established. It also involves contacting that computer or device to make sure that it is ready and able to establish a connection. Block 304 establishes a baseline connection and makes baseline connection settings. The baseline connection settings may be based on the type of connection of one or more of the client devices. These settings include the type of codec, sampling speed, transmission packet size, retransmit time, frequency to encode at, target transmission bandwidth, etc. Storage of these settings is dependent on the type of application used, as well as the nature of the client device. The discovery of the client 302 and establishment of a baseline connection 304 may occur using the connection manager 214 shown in FIG. 2.

For the purpose of this description, one client device will be referred to as the sending device 102 and the other as the recipient 118, but it should be understood that both client devices 102, 118 may perform both of these roles during the course of the two-way communication. In block 306 transmission and receiving functions commence between the two client devices 102, 118. These functions may be controlled by an application or device such as the transmission manager 212 shown in FIG. 2. Both client devices 102, 118 begin recording, encrypting, and transmitting voice data to one another.

The sending device 102 begins querying the recipient 118 for metric information. Metric information is any information about the transmission or connection, including, but not limited to, information about quality, speed, cost, interference, or problems. For example, the sending device 102 may send a request asking whether the recipient 118 is receiving all of the data being sent. If the recipient 118 is not, the sending device 102 adjusts the communication settings to slow down, use less bandwidth, switch codecs, or otherwise make adjustments to its communication settings to improve the poor reception at the recipient 118.

One embodiment of the present invention provides for an “is it better now” query and adjustment scheme. According to this scheme, the sending device 102 makes a small change and sends a request asking the recipient 118 if the quality improved. If the quality does improve, the recipient 118 notifies the sending device 102 and sending device 102 makes another small adjustment in the same direction, and again sends a request asking whether the quality has improved. This is repeated until the quality no longer improves or actually gets worse. At which point the sending device 102 goes back to the immediate prior setting as the current optimal setting. Note that this method is analogous to the typical method a stereo user applies to tune a dial stereo. The user turns the station knob in one direction, continuing to turn in one direction as the station reception improves, and then when the reception stops improving or begins to get worse, the user then turns back to the sweet spot or optimal reception position. The algorithm of certain embodiments of the present invention works in a similar way, however, instead of measuring signal strength, it measures connection quality and is automated.

FIG. 3 illustrates one way the recipient may provide information to the sending device. In block 308 one of the devices queries the other. The query may ask, for example, for metric data. The query may send a request asking whether the receiver has received all of the information that the sender has sent. In block 310, the receiver responds to the query with metric data or other information about the quality of the connection at the current communication settings. The sender receives this information. In block 312 adjustments are made to the communications settings if needed. In block 314 the connection is checked to see if it has ended. If the connection has not ended the logic returns to block 308 to again query the receiver. In this manner the sender periodically queries the receiver during the course of the connection. Note that an alternative embodiment involves only metric information sent from the receiver to the sending device without the sending device having to query the receiver. Block 308 may thus be omitted in certain embodiments.

The changes in communication settings may be based on feedback information received from the recipient device 118. This feedback information allows the sending device 102 to know the quality of the transmission and to make adjustments to its communication settings accordingly. The settings that one device adopts are based, at least in part, upon instructions or information received from the other device.

These adjustments, made in response to the metric information received, may be made by the connection manager 214 shown in FIG. 2. Such adjustments include changing the codec that is being used, changing the sampling speed, changing the packet size, changing the retransmit time, etc. These changes may be based on an algorithmic rule. One advantage of this process is that the settings are changed based on the actual transmission quality, and thus take into account whatever environmental problems or network latency problems are actually affecting the connection between the users. The connection manager may supersede these settings with values that are determined to be more appropriate. As with the user-defined settings, the storage of the actual values will depend on the nature of both the application and the client device.

The quality of connection information may take advantage of the UDP protocol commonly used in VOIP applications. UDP, unlike TCP/IP, is unacknowledged. In TCP/IP, in response to receiving a packet, the receiver 118 sends an acknowledgement of receipt to the sending device 102. In UDP, this acknowledgment does not happen. One embodiment of the present invention utilizes UDP to send the voice data and TCP/IP to send metric data about the connection quality. Another embodiment does not use TCP/IP to transmit the metric data, and instead imbeds or includes the metric data in the UDP packets containing the VOIP voice data. For example, one out of every one hundred UDP packets may contain a query packet. The receiver 118 may respond to the query after it is received. This response may also be in a UDP packet. If the receiver 118 is only receiving half of the sending device's 102 packets, then the sending device 102 is only going to get half of the responses back from the queries.

In some embodiments, the quality of connection is continuously monitored throughout the call on both ends of the connection. Thus both devices 102, 118 are acting as sending devices and receiving devices in two-way voice communication. Thus, as each is transmitting out these queries, each may also be receiving similar queries from the other party. One aspect of the present invention provides a method of synchronizing these signals so that when one device sends out a query it also responds to the other machine's query.

The querying may be done by the client device (e.g. 102, 118) itself or the gateway (e.g. 106, 114) connected to the network. VOIP typically has network server applications mediating the connection. In many case, if the server detects that the clients are able to talk to each other directly, usually when neither connection is behind a firewall or when there is a one-sided firewall, then the server may let the client devices connect directly. For this reason, it may be important to have the clients do the querying themselves rather than at the server level.

The query and response metric information is repeatedly sent during the course of a connection. These transmissions may be sent at intervals. Alternatively, the interval length could change over time, or metric data could be sent only when necessary. For example, initially the metric data could be sent on a quickly-repeating, constant basis while the initial tuning occurs. Once an optimal connection speed is approached, the frequency of metric data signals may be reduced.

The dynamic and repetitive nature of the metric data transmission between devices has additional benefits. If, during a connection, one device needs to download something or otherwise reduce the bandwidth available to the VOIP application, the VOIP communication settings may be adjusted to deal with the reduced bandwidth available. The system will recognize if the reduced bandwidth is causing a reduction in connection quality and make adjustments accordingly.

An alternative embodiment involves basing the communication settings adjustments on the different connection types that both devices are currently utilizing. These devices may be detected or determined by querying or otherwise sharing information between the devices.

Other embodiments of a connection-quality-based communication setting adjustment method include dynamically checking to detect changed conditions, having both devices query one another, providing for adjustment in the time between queries, performing the adjustments at a server rather than the client device, propagating a rule set to the client for use in making adjustments based on quality information, using flags in TCP/IP packets to indicate metrics information, using flags in UDP packets to indicate metrics information, using transmission quality and/or recipient connection type to make the adjustment determination, and using the adjustment technique in non-packet based communication systems.

Another embodiment is a method of providing data transmission, such as voice data transmission, between a first user device and a second user device. This method involves requesting the first user device to contact the second user device and identifying an address of the second user device. Next, this method involves establishing a baseline connection between the first user device and the second user device. Initial settings are made. The method further includes receiving quality information at the first user device from the second user device, wherein the information indicates the quality of data reception at the second user device. Finally, the method involves making adjustments to the sending parameters or settings of the first user device based on the quality information received from the second user device.

B. Predictive Voice Transmission

Certain embodiments of the present invention relate to predictive voice transmission. Generally, the methods according to these embodiments involve constantly recording to a buffer and then after voice is detected, going into that buffer to extract and send the appropriate voice data. This may involve backtracking a short amount or time (e.g. 0.5 seconds) in the buffer and then starting the transmitting from there. While this voice data is being transmitted, the recording device continues to record into the buffer. Thus, under ordinary circumstances voice will always be buffered before it is transmitted. When the voice is no longer detected, the device discontinues transmission when the buffer reached the appropriate point—the point in the buffered data associated with the time at which the voice was no longer detected. In contrast to conventional VOX systems and methods, recording is constant in the present inventions and transmission is sporadic. Moreover, the voice detection components are used for a different purpose. Rather than using the voice detection components to determine when to record, the voice detection components are used to determine what data to retrieve out of the buffered data to transmit to the recipient.

As described above, FIG. 2 is a system diagram of an exemplary audio engine that may be part of a client device according to one embodiment of the present invention. As shown, the basic components that may be a part of an audio engine are a recorder/player 204, a coder/decoder (“codec”) 206, a transceiver 208, a buffer 210, a transmission manager 212, and a connection manager 214. These components work together in a VOIP or voice over packet switched network to take words and sounds (sound waves) convert them to sound or voice data at the recorder 204, encode this data at the codec 206, and transmit this data using a transceiver 208. The transmission manager 212 oversees or controls these functions. Encoding at the codec 206 may involve the use of compression schemes to facilitate transmission of large amounts of information across the network or to otherwise improve performance.

One embodiment of the present invention involves using a revolving buffer 210 to store the voice data. As data is being read out of the buffer for transmission, new data is being inserted in the other end of the buffer. New data is constantly being overwritten whether voice is detected or not. The size of the buffer 210 does not need to be large. It need only be large enough to hold the portion of a word or sentence while the device recognizes that voice and activates components to read the data from the buffer 210. In most cases a buffer 210 holding 1.5 seconds worth of sound is sufficient to hold enough data. However, differences in hardware and software performance may require a longer or shorter time period be used. The present invention is not limited to a specific method of detecting voice or sound. Voice may be recognized in a variety of ways including recognizing when the decibel level exceeds a set threshold value. Voice may be monitored at the time of recording using a component of a recorder such as recorder 204 in FIG. 2 or the buffer 210 itself may be monitored for voice data. For example, if the voice data is buffered in computer memory or RAM this memory may be monitored or filtered for voice data rather than monitoring the actual sounds being recorded.

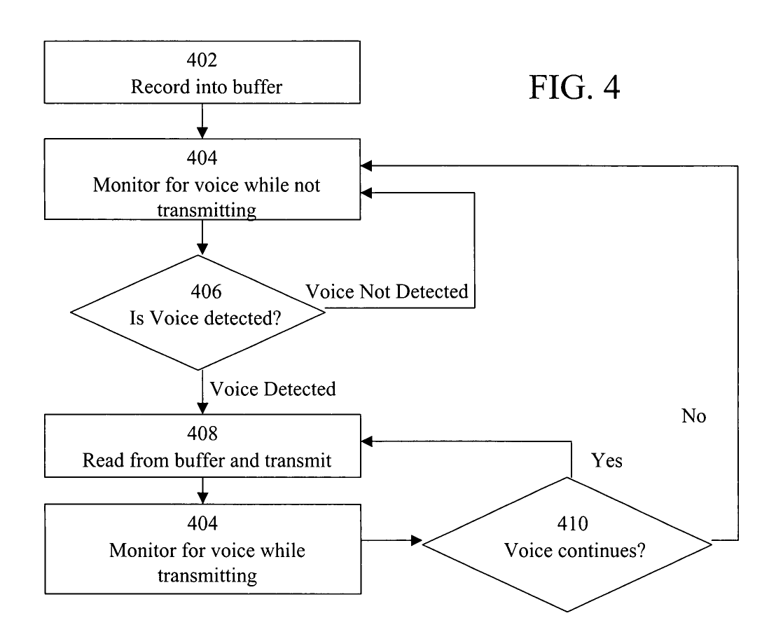

FIG. 4 is a method diagram of an exemplary method in accordance with an embodiment of the present invention. In the first block 402 recording into the buffer begins. Typically, this will occur soon after a connection is established with another device. Note that recording into the buffer 210 continues until at or near the time the connection is disconnected. In the second block 404, sound waves are measured to monitor for voice or other sound that should be transmitted to the recipient. This may be accomplished by a component of recorder/player 204, for example. More generally, a VOX component could be included in any component of the client device to measure the sound waves and recognize when voice is occurring.

At this stage, since there is no voice present, recording into the buffer is occurring but no voice or sound data is being transmitted to the recipient. If voice is not detected in block 406, then the monitoring continues without transmission, block 404. However, if voice is detected by the VOX component or other voice detection component, the transmission manager 212 will read from the buffer 210 and have the transceiver 208 transmit the buffered data, block 408. The buffered voice or sound data that is transmitted may include some data associated with the time just prior to voice being detected. This may provide for more complete voice transmission and avoid having the beginning of words inadvertently cut off in the transmission signal.

While the buffered voice is transmitting, the VOX component or other voice detection component continues to measure the sounds waves monitor for a discontinuation of the voice in block 410. If voice is discontinued, block 412, the transmission component 212 discontinues the reading from the buffer 210 and transmission from the transceiver 208 at an appropriate time and the system returns to block 404 to monitor for voice without transmission. If voice is not discontinued in block 412, then monitoring continues, block 410. In this way, the voice detection components of a system may be used to determine the appropriate portions of a buffered voice data stream to read and transmit to the recipient.

Encoding can occur during recording in block 402 or prior to transmission in block 408. In the former case, the buffered voice data is encrypted. In the later case, the buffered voice data is not encrypted, but is encrypted prior to sending or transmitting. Alternatively, the voice data may not be encoded at all.

The voice activation may be accomplished using a variety of hardware components and/or software techniques. The present methods and components may also be used in other types of voice recording and transmitting devices such as walkie-talkies and digital voice recording devices.

Another embodiment of the present invention is a method of transmitting voice data between a first user device and a second user device that involves establishing a connection between the first user device and the second user device. The method further involves continuously recording audio into a buffer using a recording device on the first user device and monitoring for voice while recording at the first user device to determine when voice data is being recorded into the buffer. Finally, the method may also involve selectively transmitting the voice data from the buffer in the first user device to the second user device.

### ALTERNATIVE EMBODIMENTS

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Many alternative embodiments are possible without departing from the spirit and scope of the invention.

What is claimed is:

1. A method of providing data transmission between a first user device and a second user device comprising:
receiving a request at the first user device to contact the second user device;
identifying an address of the second user device;
establishing a baseline connection between the first user device and the second user device using the address of the second user device, wherein initial settings are set including sending parameters for the first user device and sending parameters for the second user device;
receiving information at the first user device, wherein the information indicates the quality of data reception at the second user device; and
adjusting the sending parameters of the first user device based on the information received from the second user device.

2. The method of claim 1 wherein adjusting the sending parameters includes changing the encryption method.

3. The method of claim 1 wherein adjusting the sending parameters includes adjusting the sampling frequency.

4. The method of claim 1 wherein adjusting the sending parameters includes adjusting the compression ratio.

5. The method of claim 1 wherein the information indicating the quality of data reception at the second user device indicates the communication speed.

7. The method of claim 1 wherein the information indicating the quality of data reception at the second user device indicates the communication quality.

6. The method of claim 1 wherein the information indicating the quality of data reception at the second user device is a response to a query from the first user device.

7. The method of claim 6 wherein the query asks how much of a set amount of transmitted data was received at the second user device.

8. The method of claim 6 wherein the query asks whether transmitted data received at the second user device was received in the correct order.

9. The method of claim 1 further comprising periodically receiving information at the first user device.

10. The method of claim 1 further comprising:
receiving information at the second user device, wherein the information indicates the quality of data reception at the first user device; and
adjusting the sending parameters of the second user device based on the information received.

11. A method of transmitting voice data between a first user device and a second user device comprising:
establishing a connection between the first user device and the second user device;
recording audio continuously into a buffer on the first user device;
identifying voice data is being recorded into the buffer at the first user device; and
transmitting the voice data from the buffer at the first user device to the second user device.

12. The method of claim 11 wherein the buffer is a revolving buffer.

13. The method of claim 11 further comprising:
identifying when voice is not being recorded into the buffer at the first user device; and
discontinuing the transmission of the voice data from the buffer at the first user device.

14. The method of claim 10 wherein the recording of audio into the buffer further comprises encoding the voice data before it is placed in the buffer.

15. The method of claim 10 wherein the transmitting of the voice data from the buffer at the first user device to the second user device further comprises encoding the voice data prior to transmission.
